(19) United States
(12) Patent Application Publication
(10) Pub. No.: US 2023/0399458 A1
(43) Pub. Date: Dec. 14, 2023

(54) RESIN COMPOSITION AND MOLDED PRODUCT

(71) Applicant: ASAHI KASEI KABUSHIKI KAISHA, Tokyo (JP)

(72) Inventors: Nozomi INAGAKI, Tokyo (JP); Shinsuke MOCHIZUKI, Tokyo (JP)

(73) Assignee: ASAHI KASEI KABUSHIKI KAISHA, Tokyo (JP)

(21) Appl. No.: 18/331,172

(22) Filed: Jun. 8, 2023

(30) Foreign Application Priority Data
Jun. 14, 2022 (JP) 2022-096060

(51) Int. Cl. C08G 63/183; C08L 71/12; C08L 53/02; C08K 3/04; C08K 7/14; C08F 212/08; C08F 220/32

(52) U.S. Cl. CPC C08G 63/183; C08L 71/12; C08L 53/025; C08K 3/04; C08K 7/14; C08F 212/08; C08F 220/325; C08L 2205/035; C08L 2207/04; C08L 2205/22; C08L 2205/025; C08L 2203/30

(57) ABSTRACT

A polyethylene terephthalate resin composition with excellent impact resistance, tensile strength and chemical resistance is provided. A resin composition comprising: a (A) polyethylene terephthalate resin; a (B) polyphenylene ether resin; a (C) styrenic thermoplastic elastomer; and a (D) styrenic copolymer having a glycidyl group, wherein, a mass of the (C) component present in a phase of the (A) component, a mass of the (C) component present in a phase of the (B) component, a mass of the (A) component in the resin composition and a mass of the (B) component in the resin composition satisfy a predetermined relationship, and an average particle diameter of the phase of the (B) component dispersed in the phase of the (A) component is 0.1 to 5 μm. The resin composition can contain the (A) and (B) components as a molten and kneaded mixture.

### TECHNICAL FIELD

The present disclosure relates to a resin composition and a molded product.

### BACKGROUND

Polyethylene terephthalate (hereinafter, also simply referred to as “PET”) is a resin that has excellent gas barrier properties and chemical resistance as well as oil resistance and high strength, and thus is widely used for food packaging containers, including bottle containers, and textile applications for clothing. However, polyethylene terephthalate by itself is very brittle. Although there have been studies of reinforcing polyethylene terephthalate with glass fiber, it is currently difficult to impart sufficient impact resistance.

As such, studies have been conducted to improve impact resistance of the resin composition by adding polyphenylene ethers, elastomers and compatibilizers to polyethylene terephthalate (PTL 1) or by copolymerizing polyester elastomers with a structure different from that of polyethylene terephthalate (PTL 2).

### CITATION LIST

### Patent Literature

PTL 1: JP07-118516A PTL 2: Japanese Patent No. 3982582

### SUMMARY

However, although it is possible to impart a certain level of impact resistance to a resin composition by using the techniques described in PTL1 and PTL2, the crystallinity inherent in polyethylene terephthalate can be impaired, resulting in making it difficult to maintain the advantages of polyethylene terephthalate, such as tensile strength and chemical resistance.

It is therefore an object of the present disclosure to provide a polyethylene terephthalate resin composition with excellent impact resistance, tensile strength and chemical resistance.

In particular, the present disclosure is as follows:
[1] A resin composition comprising:
a (A) polyethylene terephthalate resin;
a (B) polyphenylene ether resin;
a (C) styrenic thermoplastic elastomer; and
a (D) styrenic copolymer having a glycidyl group,
wherein, relative to a total of 100 parts by mass of the (A) polyethylene terephthalate resin, the (B) polyphenylene ether resin, the (C) styrenic thermoplastic elastomer and the (D) styrenic copolymer having the glycidyl group,
an amount of the (A) polyethylene terephthalate resin is 40 to 90 parts by mass,
an amount of the (B) polyphenylene ether resin is 5 to 55 parts by mass,
an amount of the (C) styrenic thermoplastic elastomer is 3 to 20 parts by mass,
an amount of the (D) styrenic copolymer having the glycidyl group is 0.1 to 5 parts by mass, and
when C_{A} represents a mass of the (C) styrenic thermoplastic elastomer present in a phase of the (A) polyethylene terephthalate resin;
C_{B} represents a mass of the (C) styrenic thermoplastic elastomer present in a phase of the (B) polyphenylene ether resin;
Aₘ represents a mass of the (A) polyethylene terephthalate resin in the resin composition; and
Bₘ represents a mass of the (B) polyphenylene ether resin in the resin composition,
a relationship between a mass ratio of C_{A}/C_{B} and a mass ratio of Aₘ/Bₘ satisfies 0.05≤[C_{A}/C_{B}]/[Aₘ/Bₘ]≤0.90, and
an average particle diameter of the phase of the (B) polyphenylene ether resin dispersed in the phase of the (A) polyethylene terephthalate resin is 0.1 to 5 μm.
[2] The resin composition according to the foregoing [1], wherein the (C) styrenic thermoplastic elastomer is one or more selected from the group consisting of a hydrogenated block copolymer and a modified hydrogenated block copolymer, and
in the hydrogenated block copolymer, at least a portion of a block copolymer including a polymer block A composed mainly of a vinyl aromatic compound and a polymer block B composed mainly of a conjugated diene compound is hydrogenated.
[3] The resin composition according to the foregoing [1] or [2], wherein the (C) styrenic thermoplastic elastomer includes a styrenic thermoplastic elastomer modified with an amino group or a maleic anhydride group.
[4] The resin composition according to any one of the foregoing [1] to [3], wherein the relationship satisfies 0.05≤[C_{A}/C_{B}]/[Aₘ/Bₘ]≤0.50.
[5] A molded product comprising the resin composition according to any one of the foregoing [1] to [4].

According to the present disclosure, a polyethylene terephthalate resin composition having excellent impact resistance, tensile strength and chemical resistance can be obtained.

### DETAILED DESCRIPTION

Hereinafter, an embodiment for implementing the present disclosure (hereinafter, also referred to as the “present embodiment”) will be described in detail using examples. Note that the present disclosure is not limited to the following embodiment, and various modifications can be made within the scope of the gist.

Hereinafter, a (A) polyethylene terephthalate resin, a (B) polyphenylene ether resin, a (C) thermoplastic elastomer, a (D) styrenic copolymer having a glycidyl group and (E) other additives may simply be referred to as an (A) component, a (B) component, a (C) component, a (D) component and (E) components, respectively. Also, the (A) component, the (B) component, the (C) component and the (D) component may also simply be referred to as “four components”.

In the present specification, a hydrogenated block copolymer and a modified hydrogenated block copolymer, in which at least a portion of a block copolymer including a polymer block composed mainly of a vinyl aromatic compound and a polymer block composed mainly of a conjugated diene compound is hydrogenated, may simply be referred to as a “hydrogenated block copolymer”. Also, the hydrogenated block copolymer that is not modified may be referred to as an “unmodified hydrogenated block copolymer”, and a modified product of the hydrogenated block copolymer may be referred to as a “modified hydrogenated block copolymer”.

In the present specification, a total of 1,2-vinyl bond and 3,4-vinyl bond in a conjugated diene compound unit may be referred to as “total vinyl bond”.

[Resin Composition]

A resin composition of the present embodiment comprising:
a (A) polyethylene terephthalate resin;
a (B) polyphenylene ether resin;
a (C) styrenic thermoplastic elastomer; and
a (D) styrenic copolymer having a glycidyl group,
wherein, relative to a total of 100 parts by mass of the (A) polyethylene terephthalate resin, the (B) polyphenylene ether resin, the (C) styrenic thermoplastic elastomer and the (D) styrenic copolymer having the glycidyl group,
an amount of the (A) polyethylene terephthalate resin is 40 to 95 parts by mass,
an amount of the (B) polyphenylene ether resin is 5 to 60 parts by mass,
an amount of the (C) styrenic thermoplastic elastomer is 3 to 20 parts by mass,
an amount of the (D) styrenic copolymer having the glycidyl group is 0.1 to 5 parts by mass, and
when C_{A} represents a mass of the (C) styrenic thermoplastic elastomer present in a phase of the (A) polyethylene terephthalate resin;
C_{B} represents a mass of the (C) styrenic thermoplastic elastomer present in a phase of the (B) polyphenylene ether resin;
Aₘ represents a mass of the (A) polyethylene terephthalate resin in the resin composition; and
Bₘ represents a mass of the (B) polyphenylene ether resin in the resin composition,
a relationship between a mass ratio of C_{A}/C_{B} and a mass ratio of Aₘ/Bₘ satisfies 0.05≤[C_{A}/C_{B}]/[Aₘ/Bₘ]≤0.90, and
an average particle diameter of the phase of the (B) polyphenylene ether resin dispersed in the phase of the (A) polyethylene terephthalate resin is 0.1 to 5 μm.

Hereinafter, components of the resin composition of the present embodiment will be described.

(A) Polyethylene Terephthalate Resin

The (A) component used herein is composed mainly of terephthalic acid and ethylene glycol.

In the (A) component, as an acid component other than terephthalic acid, aromatic dicarboxylic acids such as isophthalic acid, 5-sodium sulfoisophthalic acid, 2,6-naphthalene dicarboxylic acid, 4,4′-diphenyl dicarboxylic acid and diphenylsulfonic dicarboxylic acid; aromatic polycarboxylic acids such as trimellitic acid, pyromellitic acid and their acid anhydrides; aliphatic dicarboxylic acids such as oxalic acid, succinic acid, adipic acid, sebacic acid, azelaic acid and decanedicarboxylic acid may be copolymerized.

In the (A) component, also, as an alcohol component other than ethylene glycol, aliphatic diols such as propylene glycol, 1,2-propanediol, 1,3-propanediol, 1,2-butanediol, 1,3-butanediol, 1,4-butanediol, 2,3-butanediol, diethylene glycol, 1,5-pentanediol, neopentyl glycol, triethylene glycol and polyethylene glycol; aliphatic polyhydric alcohols such as trimethylolpropane and pentaerythritol; alicyclic diols such as 1,4-cyclohexanedimethanol and 1,4-cyclohexanediethanol; aromatic diols such as ethylene oxide adducts of bisphenol A and bisphenol S; and hydroxycarboxylic acids such as 4-hydroxybenzoic acid and F-caprolactone may be copolymerized.

Amounts of the acid component other than terephthalic acid and the alcohol component other than ethylene glycol may be appropriately adjusted and preferably used within ranges that do not compromise properties of the (A) component. Preferably, the amount of the acid component other than terephthalic acid is less than 5 mol % relative to 100 mol % of the acid component comprising the (A) component. Preferably, the amount of the alcohol component other than ethylene glycol is less than 5 mol % relative to 100 mol % of the alcohol component comprising the (A) component. When the amount of the acid component other than terephthalic acid and the amount of the alcohol component other than ethylene glycol are less than 5 mol %, mechanical properties, crystallinity and flowability can be maintained.

Also, an intrinsic viscosity of the (A) component measured in a phenol/1,1,2,2-tetrachloroethane (60/40 by weight) mixed solvent at 30° C. is preferably 0.05 to 1.20 dl/g, and more preferably 0.10 to 1.0 dl/g, from the viewpoint of balancing the flowability and the mechanical properties.

Polyethylene terephthalate obtained by washing and pulverizing an end piece of a used bottle or film may be used as a portion of, or an entirety of, the (A) component.

The (A) component of a single type or in combination of two or more types may be used.

An amount of the (A) component is 40 to 90 parts by mass relative to a total of 100 parts by mass of the four components. In one embodiment, the amount of the (A) component is 45 parts by mass or more, 50 parts by mass or more, 55 parts by mass or more, 60 parts by mass or more, 65 parts by mass or more, 70 parts by mass or more, 75 parts by mass or more, 80 parts by mass or more, or 85 parts by mass or more, relative to the total of 100 parts by mass of the four components. In another embodiment, the amount of the (A) component is 90 parts by mass or less, 85 parts by mass or less, 80 parts by mass or less, 75 parts by mass or less, 70 parts by mass or less, 65 parts by mass or less, 60 parts by mass or less, 55 parts by mass or less, or 50 parts by mass or less, relative to the total of 100 parts by mass of the four components.

(B) Polyphenylene Ether Resin

The (B) polyphenylene ether resin used in the present disclosure includes, but is not limited to, for example, polyphenylene ether or modified polyphenylene ether.

From the viewpoint of further improving flame retardance of the resin composition, a reduced viscosity of the (B) component is preferably 0.25 dL/g or more, more preferably 0.28 dL/g or more, preferably 0.60 dL/g or less, more preferably 0.57 dL/g or less, and particularly preferably 0.55 dL/g or less. The reduced viscosity can be controlled through a polymerization time or an amount of a catalyst.

The reduced viscosity can be measured using a chloroform solution of ηₛₚ/c: 0.5 g/dL with a Ubbelohde viscometer at a temperature of 30° C.
—Polyphenylene ether—

Polyphenylene ether includes, but is not limited to, for example, one or more selected from the group consisting of a monopolymer comprising a repeating unit structure represented by a formula (1) set forth below and a copolymer having a repeating unit structure represented by the formula (1).

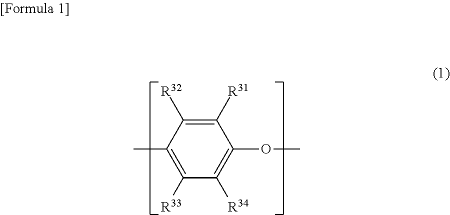

[In the formula, R³¹, R³², R³³ and R³⁴ are independently a monovalent group selected from the group consisting of a hydrogen atom, a halogen atom, a primary alkyl group having 1 to 7 carbon atoms, a secondary alkyl group having 2 to 7 carbon atoms, a phenyl group, a haloalkyl group having 2 to 7 carbon atoms, an aminoalkyl group having 2 to 7 carbon atoms, an oxyhydrocarbon group having 2 to 7 carbon atoms, and a halohydrocarbonoxy group in which at least two carbon atoms separate the halogen atom and the oxygen atom from each other.]

Polyphenylene ether is not particularly limited, and well-known ones may be used. Polyphenylene ether includes, for example, a monopolymer such as poly(2,6-dimethyl-1,4-phenylene ether), poly(2-methyl-6-ethyl-1,4-phenylene ether), poly(2-methyl-6-phenyl-1,4-phenylene ether), poly(2,6-dichloro-1,4-phenylene ether), etc., and a copolymer such as a copolymer of 2,6-dimethylphenol and other phenols such as 2,3,6-trimethylphenol and 2-methyl-6-butylphenol. Polyphenylene ether is preferably poly(2,6-dimethyl-1,4-phenylene ether) or a copolymer of 2,6-dimethylphenol and 2,3,6-trimethylphenol, and more preferably poly(2,6-dimethyl-1,4-phenylene ether).

A method for producing polyphenylene ether is not particularly limited, and well-known methods can be employed. For example, the method for producing polyphenylene ether may include the method described in U.S. Pat. No. 3,306,874, etc., where polyphenylene ether is produced by oxidative polymerization of 2,6-xylenol using a complex of cuprous salt and amine as a catalyst.

—Modified Polyphenylene Ether—

Examples of the modified polyphenylene ether include, but are not particularly limited to, for example, those obtained by grafting, adding, or grafting and adding styrene polymers, derivatives thereof, or both of them to polyphenylene ether. A ratio of mass increase by the grafting, adding or grafting and adding includes, but is not particularly limited to, preferably 0.01% by mass or more, preferably 10% by mass or less, more preferably 7% by mass or less, and particularly preferably 5% by mass or less, relative to 100% by mass of modified polyphenylene ether.

A method for producing modified polyphenylene ether includes, but is not limited to, for example, a method that causes polyphenylene ether to react with styrene polymer, a derivative thereof, or styrene polymer and a derivative thereof, in the presence or absence of a radical generator, in a molten state, a solution state, or a slurry state at 80 to 350° C.

In a case where the (B) component is a mixture of polyphenylene ether and modified polyphenylene ether, a mixing ratio of polyphenylene ether and modified polyphenylene ether is not particularly limited and may be any ratio.

The (B) component of a single type or in combination of two or more types may be used.

A content of the (B) component is 5 to 55 parts by mass relative to the total of 100 parts by mass of the four components. In one embodiment, the amount of the (B) component is 5 parts by mass or more, 10 parts by mass or more, 15 parts by mass or more, 20 parts by mass or more, 25 parts by mass or more, 30 parts by mass or more, 35 parts by mass or more, 40 parts by mass or more, 45 parts by mass or more, or 50 parts by mass or more, relative to the total of 100 parts by mass of the four components. In another embodiment, the amount of the (B) component is 55 parts by mass or less, 50 parts by mass or less, 45 parts by mass or less, 40 parts by mass or less, 35 parts by mass or less, 30 parts by mass or less, 25 parts by mass or less, 20 parts by mass or less, 15 parts by mass or less, or 10 parts by mass or less, relative to the total of 100 parts by mass of the four components.

(C) Styrenic Thermoplastic Elastomer

Styrenic thermoplastic elastomer used as the (C) component is used to improve impact resistance of the compositions disclosed herein.

The (C) component includes, for example, SBS (polystyrene-polybutadiene-polystyrene), SIS (polystyrene-polyisoprene-polystyrene), SEBS (polystyrene-polyethylene/polybutylene-polystyrene), SBBS (polystyrene-polybutadiene/polybutylene-polystyrene), and SEPS (polystyrene-polyethylene/polypropylene-polystyrene), as well as their modified products. Among them, from the viewpoint of imparting impact resistance more efficiently to the resin composition of the present disclosure without impairing other mechanical properties, one or more selected from the group consisting of the hydrogenated block copolymer (typical examples: SEBS, SBBS, SEPS), in which at least a portion of a block copolymer including at least one polymer block A composed mainly of a vinyl aromatic compound and at least one polymer block B composed mainly of a conjugated diene compound is hydrogenated, and the modified hydrogenated block copolymer are preferably used.

The (C) component may contain blocks other than the polymer block A and the polymer block B. However, the (C) component preferably comprises the polymer block A and the polymer block B alone, and more preferably comprises one type of the polymer block A and one type of the polymer block B.

The (C) component of a single type or in combination of two or more types may be used.

—Polymer Block A—

The polymer block A composed mainly of the vinyl aromatic compound includes a homopolymer block of the vinyl aromatic compound, a copolymer block of the vinyl aromatic compound and a conjugated diene compound, and the like. The polymer block A is preferably a homopolymer block of the vinyl aromatic compound or a copolymer block of the vinyl aromatic compound and the conjugated diene compound containing more than 50% by mass (preferably more than 70% by mass) of a vinyl aromatic compound unit.

The polymer block A “composed mainly of the vinyl aromatic compound” means that the polymer block A contains more than 50% by mass of the vinyl aromatic compound unit before hydrogenation. Preferably, the polymer block A contains more than 70% by mass of the vinyl aromatic compound unit.

The vinyl aromatic compound includes, but is not limited to, for example, styrene, α-methylstyrene, vinyltoluene, p-tert-butylstyrene, diphenylethylene and the like. The vinyl aromatic compound is preferably styrene.

The conjugated diene compound includes conjugated diene compounds described below, and is preferably butadiene, isoprene or a combination thereof. The conjugated diene compound of a single type or in combination of two or more types may be used.

In the polymer block A, a distribution of the vinyl aromatic compound, the conjugated diene compounds and the like in a molecular chain of the polymer block may be random, tapered (where monomer components increase or decrease along the molecular chain), partially block-shaped, or any combination thereof.

In a case where there are two or more polymer blocks A in the (C) component, these polymer blocks A may have the same structure or different structures.

The polymer block A has a number-average molecular weight (Mn) of preferably between 5,000 and 28,000, more preferably between 5,000 and 25,000, and further preferably between 10,000 and 25,000, from the viewpoint of attaining even more excellent rigidity, impact resistance and chemical resistance.

—Polymer Block B—

The polymer block B composed mainly of the conjugated diene compound includes a homopolymer block of the conjugated diene compound, a random copolymer block of the conjugated diene compound and the vinyl aromatic compound, and the like. The polymer block B is preferably a homopolymer block of the conjugated diene compound or a copolymer block of the conjugated diene compound and the vinyl aromatic compound containing more than 50% by mass (preferably more than 70% by mass) of a conjugated diene compound unit.

The polymer block B “composed mainly of the conjugated diene compound” means that the polymer block B contains more than 50% by mass of the conjugated diene compound unit before hydrogenation. Preferably, the polymer block B contains more than 70% by mass of the conjugated diene compound unit.

The conjugated diene compound includes, but is not limited to, for example, butadiene, isoprene, 1,3-pentadiene, 2,3-dimethyl-1,3-butadiene and the like. The conjugated diene compound is preferably butadiene, isoprene or a combination thereof.

The vinyl aromatic compound includes the vinyl aromatic compound mentioned above and is preferably styrene. The vinyl aromatic compound of a single type or in combination of two or more types may be used.

In the polymer block B, a distribution of the conjugated diene compound, the vinyl aromatic compound and the like in a molecular chain of the polymer block may be random, tapered (where monomer components increase or decrease along the molecular chain), partially block-shape, or any combination thereof.

In a case where there are two or more polymer blocks B in the (C) component, these polymer blocks B may have the same structure or different structures.

The hydrogenation ratio to ethylenic double bond in the conjugated diene compound unit in the polymer block B is preferably between 50% and 100%, and more preferably between 60% and 100%, from the viewpoint of attaining even more excellent rigidity, chemical resistance or impact resistance.

A ratio of a total of 1,2-vinyl bond and 3,4-vinyl bond to ethylenic double bond in the conjugated diene compound unit in the polymer block B is preferably between 25% and 70%, and more preferably between 25 and 60%, from the viewpoint of attaining even more excellent rigidity, impact resistance and chemical resistance.

In the present specification, the total of 1,2-vinyl bond and 3,4-vinyl bond (a total vinyl bond amount) refers to a ratio of the total of 1,2-vinyl bond and 3,4-vinyl bond to a total amount of 1,2-vinyl bond, 3,4-vinyl bond and 1,4-conjugated bond in the conjugated diene compound unit in the polymer block containing the conjugated diene compound before hydrogenation. The total vinyl bond amount can be measured with an infrared spectrophotometer and calculated according to the method described in Analytical Chemistry, Volume 21, No. 8, August 1949.

An Mn of the polymer block B is preferably between 20,000 and 150,000, and more preferably between 30,000 and 120,000, from the viewpoint of attaining even more excellent rigidity, impact resistance and chemical resistance.

The polymer block B may be a single polymer block in which the ratio of the total of 1,2-vinyl bond and 3,4-vinyl bond to ethylenic double bond in the conjugated diene compound unit contained in the polymer block B is between 25% and 70%. The polymer block B may be a polymer block composed mainly of a conjugated diene compound comprising both a polymer block B1 composed mainly of a conjugated diene compound in which the ratio of the total of 1,2-vinyl bond and 3,4-vinyl bond is between 25% and 70% and a polymer block B2 composed mainly of a conjugated diene compound in which the ratio of the total of 1,2-vinyl bond and 3,4-vinyl bond is between 45% and 70%.

When “A” represents the polymer block, “B 1” represents the polymer block B1, and “B2” represents the polymer block B2, a structure of the block copolymer comprising both the polymer block B1 and the polymer block B2 is expressed by, for example, A-B2-B1-A, A-B2-B1, or the like, and can be obtained by a known polymerization method for controlling the total vinyl bond amount based on an adjusted feed sequence of each monomer unit.

—Structure of Hydrogenated Block Copolymer—

When “A” represents the polymer block A and “B” represents the polymer block B, a structure of the hydrogenated block copolymer in the (C) component is, for example, A-B type, A-B-A type, B-A-B-A type, (A-B-)ₙ-X type (where n is an integer of 1 or larger, and X is a reaction residue of a polyfunctional coupling agent such as silicon tetrachloride or tin tetrachloride, or a residue of an initiator such as a polyfunctional organolithium compound), A-B-A-B-A type, or the like.

Referring to the block structure, preferably, the polymer block B is a homopolymer block of the conjugated diene compound or a copolymer block of the conjugated diene compound and the vinyl aromatic compound containing more than 50% by mass (preferably more than 70% by mass) of the conjugated diene compound unit, and the polymer block A is a homopolymer block of the vinyl aromatic compound or a copolymer block of the vinyl aromatic compound and the conjugated diene compound containing more than 50% by mass (preferably more than 70% by mass) of the vinyl aromatic compound.

A molecular structure of the hydrogenated block copolymer in the (C) component may be, but is not limited to, for example, linear, branched, radial, or any combination thereof.

—Content of Vinyl Aromatic Compound Unit—

The content of the vinyl aromatic compound unit (a hydrogenated block copolymer constituent unit derived from the vinyl aromatic compound) in the (C) component before hydrogenation is not particularly limited and preferably 10 to 70% by mass, more preferably 20 to 70% by mass, more preferably 20 to 60% by mass, more preferably 30 to 50% by mass, and particularly preferably 30 to 40% by mass, from the viewpoint of heat resistance and tensile strength of the resin composition.

—Total Vinyl Bond Amount—

The ratio of the total of 1,2-vinyl bond and 3,4-vinyl bond to ethylenic double bond in the conjugated diene compound unit contained in the (C) component is preferably between 25% and 70%, more preferably between 25% and 55%, and particularly preferably between 25% and 60%. When the ratio of the total of 1,2-vinyl bond and 3,4-vinyl bond is less than 70%, the impact resistance of the resin composition is improved. When the ratio is 60% or less, the impact resistance is further improved. When the ratio of the total of 1,2-vinyl bond and 3,4-vinyl bond is 25% or more, the compatibility with the (B) component is improved.

A method for controlling the ratio of the total of 1,2-vinyl bond and 3,4-vinyl bond to 5 to 70% includes, but is not limited to, for example, adding a 1,2-vinyl bond volume regulator or adjusting polymerization temperature in producing the (C) component.

The “total of 1,2-vinyl bond and 3,4-vinyl bond to the double bond in the conjugated diene compound unit” refers to the total of 1,2-vinyl bond and 3,4-vinyl bond relative to the double bond (ethylenic double bond) in the conjugated diene compound unit in the block copolymer before hydrogenation of the block copolymer. For example, the block copolymer before hydrogenation can be measured with an infrared spectrophotometer and calculated by the Hampton method. It can also be calculated from the block copolymer after hydrogenation using NMR.

—Hydrogenation Ratio—

In the (C) component, the hydrogenation ratio to ethylenic double bond (the double bond in the conjugated diene compound unit) in the block copolymer is preferably 50% or more and 100% or less, and more preferably 60% or more and 100% or less. When the hydrogenation ratio is within the range of 50% or more and 100% or less, the impact resistance of the resin composition is improved.

The (C) component having such a hydrogenation ratio can be easily obtained by, for example, controlling an amount of hydrogen consumed in a hydrogenation reaction of ethylenic double bond of the block copolymer to a desired hydrogenation ratio (e.g., between 50% and 100%).

The hydrogenation ratio can be determined by, for example, quantifying an amount of the double bond remaining in the polymer block B using NMR measurement.

More preferably, the ratio of the total of 1,2-vinyl bond and 3,4-vinyl bond to ethylenic double bond in the conjugated diene compound unit contained in the (C) component is less than 60%, and the hydrogenation ratio of ethylenic double bond in the (C) component is 80% or more, whereby thermal stability of the resin composition during processing is improved.

—Molecular Weight Peak—

A molecular weight peak of the (C) component after hydrogenation in standard polystyrene equivalent by GPC measurement is preferably 10,000 to 250,000, more preferably 30,000 to 200,000, from the viewpoint of rigidity, impact resistance and chemical resistance.

A method for controlling the molecular weight peak of the (C) component within the range of 10,000 to 250,000 includes, but is not limited to, for example, adjusting the amount of a catalyst in the polymerization process.

In the present specification, the molecular weight peak can be measured under the conditions described below using Gel Permeation Chromatography System 21 (manufactured by Resonac Holdings Corporation). In this measurement, a column consisting of one K-G, one K-800RL and one K-800R all manufactured by Resonac Holdings Corporation connected in series is used, and column temperature is set to 40° C. Also, chloroform is used as a solvent, and a solvent flow rate is set to 10 mL/min. Further, sample concentration is set to 1 g of the hydrogenated block copolymer per 1 L of chloroform solution. In addition, a calibration curve is prepared using standard polystyrene (a molecular weight of standard polystyrene is 3,650,000, 2,170,000, 1,090,000, 681,000, 204,000, 52,000, 30,200, 13,800, 3,360, 1,300, 550). For the measurement, a UV (ultraviolet) wavelength of a detection unit is set to 254 nm for both standard polystyrene and the hydrogenated block copolymer.

The (C) component has a molecular weight distribution (Mw/Mn) before hydrogenation of preferably 1.01 to 1.50, and more preferably 1.03 to 1.40, from the viewpoint of attaining even more excellent rigidity, impact resistance and chemical resistance.

—Production Method—

The method for producing the hydrogenated block copolymer in the (C) component is not particularly limited, and well-known production methods can be employed. For example, the method for producing the hydrogenated block copolymer includes one described in JP47-11486A, U.S. Pat. No. 3,281,383, or the like.

—Modified Hydrogenated Block Copolymer—

The modified hydrogenated block copolymer in the (C) component includes, for example, a modified hydrogenated block copolymer obtained by reacting a hydrogenated block copolymer (especially an unmodified hydrogenated block copolymer) with α,β-unsaturated carboxylic acid or its derivative (an ester compound or an acid anhydride compound) in the presence or absence of a radical generating agent at 80 to 350° C. in a molten state, a solution state or a slurry state (in this case, α,β-unsaturated carboxylic acid or its derivative is preferably grafted or added to the unmodified hydrogenated block copolymer at a ratio of 0.01-10% by mass), a polymer having amino groups of a specific structure at its end obtained by a process of polymerizing a monomer containing at least one conjugated diene monomer using an organic lithium compound as an initiator and a process of adding a urea derivative, and the like.

In a case where the unmodified hydrogenated block copolymer and the modified hydrogenated block copolymer are used together as the (C) component, a mixing ratio of the unmodified hydrogenated block copolymer and the modified hydrogenated block copolymer can be determined without any particular restrictions.

The (C) component of a single type or in combination of two or more types may be used.

The amount of the (C) component is 3 to 20 parts by mass relative to the total of 100 parts by mass of the four components. In one embodiment, the amount of the (C) component is 3 parts by mass or more, 4 parts by mass or more, 5 parts by mass or more, 6 parts by mass or more, 7 parts by mass or more, 8 parts by mass or more, 9 parts by mass or more, 10 parts by mass or more, 15 parts by mass or more, or 18 parts by mass or more, relative to the total of 100 parts by mass of the four components. In another embodiment, the amount of the (C) component is 20 parts by mass or less, 18 parts by mass or less, 15 parts by mass or less, 10 parts by mass or less, 9 parts by mass or less, 8 parts by mass or less, 7 parts by mass or less, 6 parts by mass or less, 5 parts by mass or less, or 4 parts by mass or less, relative to the total of 100 parts by mass of the four components.

(D) Styrenic Copolymer Having Glycidyl Group

The (D) component interacts with the (A) component, the (B) component, or both of them, and acts as a compatibilizer of the (A) component and the (B) component.

In particular, when being used as a compatibilizer, the (D) component acts as an emulsifier for mixing the (A) component and the (B) component and provides excellent effects on balancing between heat resistance, impact resistance and tensile strength of the resin composition.

From the viewpoint of better miscibility with the (B) component, the (D) component contains preferably at least 65% by weight, more preferably 75 to 95% by weight, of a styrene monomer unit.

The (D) component of a single type or in combination of two or more types may be used.

A preferred amount of the (D) component used in the present disclosure is 0.1 to 5 parts by mass relative to the total of 100 parts by mass of the four components. In one embodiment, the amount of the (D) component is 0.1 parts by mass or more, 0.3 parts by mass or more, 0.5 parts by mass or more, 1.0 parts by mass or more, 1.5 parts by mass or more, 2.0 parts by mass or more, 2.5 parts by mass or more, 3.0 parts by mass or more, 3.5 parts by mass or more, 4.0 parts by mass or more, or 4.5 parts by mass or more, relative to the total of 100 parts by mass of the four components. In another embodiment, the amount of the (D) component is 5.0 parts by mass or less, 4.5 parts by mass or less, 4.0 parts by mass or less, 3.5 parts by mass or less, 3.0 parts by mass or less, 2.5 parts by mass or less, 2.0 parts by mass or less, 1.5 parts by mass or less, 1.0 parts by mass or less, 0.5 parts by mass or less, or 0.3 parts by mass or less, relative to the total of 100 parts by mass of the four components.

Ratio of (C) Component Present in Phase of (A) Component and Phase of (B) Component

When C_{A} represents a mass of the (C) component present in the a phase of the (A) component, C_{B} represents a mass of the (C) component present in a phase of the (B) component, Aₘ represents a mass of the (A) component present in the resin composition, and Bₘ represents a mass of the (B) component present in the resin composition, a relationship between a mass ratio of C_{A}/C_{B} and a mass ratio of Aₘ/Bₘ satisfies 0.05≤[C_{A}/C_{B}]/[Aₘ/Bₘ]≤0.90, from the viewpoint of impact resistance and chemical resistance of the resin composition. Hereinafter, [C_{A}/C_{B}]/[Aₘ/Bₘ] may be referred to as Rₘ.

In one embodiment, Rₘ satisfies 0.05 or more, 0.06 or more, 0.07 or more, 0.08 or more, 0.09 or more, 0.10 or more, 0.11 or more, 0.12 or more, 0.13 or more, 0.14 or more, 0.15 or more, 0.16 or more, 0.17 or more, 0.18 or more, 0.19 or more, 0.20 or more, 0.25 or more 0.30 or more, 0.35 or more, 0.40 or more, 0.45 or more, 0.50 or more, 0.55 or more, 0.60 or more, 0.65 or more, 0.70 or more, 0.75 or more, 0.80 or more, or 0.85 or more. In another embodiment, Rₘ is 0.90 or less, 0.85 or less, 0.80 or less, 0.75 or less, 0.70 or less, 0.65 or less, 0.60 or less, 0.55 or less, 0.50 or less, 0.45 or less, 0.40 or less, 0.35 or less, 0.30 or less, 0.25 or less, 0.20 or less, 0.19 or less, 0.18 or less, 0.17 or less, 0.16 or less, 0.15 or less, 0.14 or less, 0.13 or less, 0.12 or less, 0.11 or less, 0.10 or less, 0.09 or less, 0.08 or less, 0.07 or less, or 0.06 or less.

Due to the characteristics of each component constituting the resin composition, the resin composition has a morphology in which the (A) component forms a sea, the (B) component forms an island, and the (C) component is present in both the sea and the island. Also, since the (C) component is compatible with the (B) component, most of the (C) component in general tends to be present in the (B) component. Therefore, a value of Rₘ becomes much smaller than 0.05. In contrast, the present disclosure is characterized by having more of the (C) component present in the (A) component, whereby 0.05≤Rₘ≤0.90 is satisfied.

Methods for adjusting Rₘ to the range of 0.05 to 0.90 include, for example, (1) to (3) set forth below.

(1) In producing a composition containing the (A) component and the (B) component, it is commonly practiced supplying the (B) component from a top of a melting and kneading machine and the (A) component from a side of the kneading machine. To our surprise, in contrast, feeding a certain amount of the (A) component also from the top of the melting and kneading machine has an impact on a position where the (C) component is present and satisfies the characteristic of the present disclosure, 0.05≤Rₘ≤0.90. Although this is a matter of speculation, it can be said that supplying a small amount of the (A) component from the top and the rest of the (A) component from the side reverses the sea-island structure (phase transition; the sea formed by the B component is transitioned to the sea formed by the A component) after the (A) component is supplied from the side, affecting the position where the (C) component is present.

In the case of the method (1) set forth above, preferably, the (D) component is also supplied from the top of the melting and kneading machine. By reacting the (D) component having a highly reactive glycidyl group with the (A) component in the certain amount described above, the number of end groups of the (A) component that can react with a modified styrene-butadiene copolymer can be increased, facilitating the dispersion of the (C) component in the phase of the (A) component. That is, C_{A} can be increased. From the viewpoint of the above, too, it is preferable that the amount of the (A) component fed from the top be the certain amount or less. A ratio of the (A) component supplied from the top of the melting and kneading machine is, for example, 50% by mass or less of the (A) component to be used for the entire resin composition. More preferably, it is 30% by mass or less, and most preferably 10% by mass or less.

(2) Using the (C) component formulated by combining a styrene-butadiene copolymer unmodified with a functional group and a styrene-butadiene copolymer modified with a functional group capable of reacting with the end group of the (A) component in a certain ratio, 0.05≤Rₘ≤0.90 can be satisfied. In general, a compatibility of the (B) component with a styrene-butadiene copolymer is significantly higher than a compatibility of the (A) component with a styrene-butadiene copolymer. Therefore, the use of a combination of the unmodified copolymer and the modified copolymer in a certain ratio can prevent the (C) component from dispersing in the (B) component alone. That is, C_{B} can be reduced. Such a certain ratio is, for example, a mass ratio of the copolymer unmodified with a functional group to the copolymer modified with a functional group: 1:9 to 9:1, 2:8 to 8:2, 3:7 to 7:3, 4:6 to 6:4 or 5:5.

(3) A method using a pelletized material obtained by melting and kneading in advance the (A) component and a styrene-butadiene copolymer modified with a functional group as the (C) component, 0.05≤Rₘ≤0.90 can be satisfied.

In the case of the method (3), the ratio of the (A) component to the (C) component contained in the pellets that have been molten and kneaded in advance preferably satisfies, but is not particularly limited to, the (A) component: the (C) component (mass ratio)=98:2 to 60:40, and more preferably 95:5 to 70:30, from the viewpoint of obtaining a desired morphology and maintaining impact resistance of a final resin composition.

Also, since a method for feeding the pellets that have been molten and kneaded in advance to the kneading machine is not particularly limited in carrying out melting and kneading to obtain the final resin composition, the (A) component is preferably added from the side of the kneading machine, from the viewpoint of obtaining the desired morphology and maintaining impact resistance of the final resin composition.

The amounts of C_{A} and C_{B} in the resin composition are determined according to the following method: 500 mg of a sample, which has been frozen and pulverized, is added to 10 mL of toluene, left stand at room temperature for 18 hours, and then centrifuged at 3000 rpm at 20° C. for 1 hour to separate into supernatant and precipitate. The resulting supernatant is vacuum dried and designated as “concentrate 1”. The concentrate 1 is vacuum dried to volatilize all the solvent. Next, 10 mL of chloroform is added to the resulting concentrate 1 and dissolved therein at room temperature, and fractions of the resulting mixture are subjected to ¹H-NMR measurement in deuterated chloroform to determine peak areas of signals respectively corresponding to the (B) component and the (C) component and, from a total weight of the “concentrate 1”, an amount of the (B) component and an amount of the (C) component C_{T} soluble in toluene. Also, to the fractions that turn into precipitate in the first centrifugation step, 10 mL of a first mixed solvent in which hexafluoroisopropanol (HFIP): chloroform=1:1 (volume ratio) is added, and thus obtained mixture is left stand at room temperature for 18 hours. The mixture is then centrifuged at 3000 rpm at 20° C. for 1 hour to separate into supernatant and precipitate. The resulting supernatant is vacuum dried and designated as “concentrate 2”. The concentrate 2 is vacuum dried to volatilize all the solvent, and then molten in 20 mL of a mixed solvent in which HFIP: chloroform=1:3 (volume ratio) at 40° C. Fractions of the resulting mixture 2 are subjected to ¹H-NMR measurement in a mixed solvent in which heavy HFIP: heavy chloroform=3:2 (volume ratio) to determine peak areas of signals respectively corresponding to the (A) component and the (C) component and, from a total weight of the “concentrate 2”, the amount of the (A) component and the amount of the (C) component C_{H} soluble in the first mixed solvent. In this way, the amounts of the (A) component, the (B) component and the (C) component (a total amount of C_{T} and C_{H}) in the resin composition are first determined. Next, 500 mg of the same frozen and pulverized sample is added to 20 mL of chloroform and shaken at room temperature for 6 hours. The resulting solution is filtered through a disposable filter with a 0.45 m mesh opening. The extracted solution is air-dried. The resulting solution is vacuum dried at 60° C. for 12 hours. An amount of residue after the vacuum drying is considered to be a total amount of the (B) component and a C_{B} component. An amount of C_{B} is obtained by subtracting the previously determined amount of the (B) component from this total amount. Then, the amount of C_{A} is obtained by subtracting the amount of C_{B} from the previously determined amount of the (C) component.

[Dispersion State of (A) Component and (B) Component]

In the resin composition, the phase of the (B) component is dispersed in a particulate form in the phase of the (A) component, and the average particle diameter of the phase of the (B) component is 0.1 to 5 μm. In one embodiment, the average particle diameter of the phase of the (B) component is 0.1 m or more, 0.2 m or more, 0.5 m or more, 0.9 m or more, 1.0 m or more, 1.1 m or more, 1.2 m or more, 1.3 m or more, 1.4 m or more, 1.5 m or more, 1.6 m or more, 1.7 m or more, 1.8 m or more, 1.9 m or more, 2.0 m or more, 2.5 m or more, 3.0 m or more, 3.5 m or more, 4.0 m or more, or 4.5 m or more. In another embodiment, the average particle diameter of the phase of the (B) component is 5.0 m or less, 4.8 m or less, 4.5 m or less, 4.0 m or less, 3.5 m or less, 3.0 m or less, 2.5 m or less, 2.0 m or less, 1.9 m or less, 1.8 m or less, 1.7 m or less, 1.6 m or less, 1.5 m or less, 1.4 m or less, 1.3 m or less, 1.2 m or less, 1.1 m or less, 1.0 m or less, 0.9 m or less, or 0.5 m or less.

In the resin composition of the present disclosure, it is preferable that the phase containing the (A) component forms a matrix (a continuous phase), from the viewpoint of improving chemical resistance and bonding ability (adhesive strength) to metals for metal insert molding and the like. On the other hand, the phase containing the (B) component may form a dispersed phase in the matrix. The dispersed phase is preferably in a particulate form in appearance, in which case the average particle diameter of the dispersed phase is preferably 0.1 to 5.0 m, and more preferably 0.2 to 4.0 μm.

The average particle diameter of the dispersed phase can be measured by the procedure described in the embodiment.

(E) Other Additives

The resin composition of the present embodiment may further contain the (E) other additives. An amount of the (E) component to be added is not particularly limited as long as the object of the present invention can be achieved. From the viewpoint of imparting high mechanical properties to the resin composition, it is preferably 5 to 100 parts by mass, and more preferably 10 to 90 parts by mass, with respect to the total of 100 parts by mass of the four components (A) to (D).

The (E) other additives are compounds other than the four components. The (E) components include, for example, thermoplastic elastomers other than the (C) component, inorganic fillers such as glass fiber, antioxidants, metal deactivators, heat stabilizers, flame retardants (condensed phosphate esters, phosphinates, ammonium polyphosphate compounds, magnesium hydroxide, aromatic halogenated flame retardants, silicone flame retardants, zinc borates, etc.), fluorinated polymers, plasticizers (low molecular weight polyethylene, epoxidized soybean oil, polyethylene glycol, fatty acid esters, etc.), flame retardants such as antimony trioxide, weathering improvers, light resistance improvers, nucleating agents, slip agents, coloring agents such as carbon black, mold release agents, and the like. In particular, it is preferable to add glass fiber for the purpose of improving tensile strength and heat resistance of the resin composition, and to add carbon black for the purpose of stabilizing physical properties in a short period of time after molding.

(Method for Manufacturing Resin Composition)

The resin composition of the present embodiment can be produced by melting and kneading the four components and, if necessary, the (E) components.

Generally, the resin composition comprising the four components is produced by a method including the following steps (1) and (2).
(1): a step of melting and kneading the (B) component, the (C) component and the (D) component to obtain a kneaded mixture; and
(2): a step of adding the (A) component to the kneaded mixture obtained in the step (1) and melting and kneading the resulting mixture.

On the other hand, in a production method for obtaining the resin composition of the present embodiment, it is preferable to add the (C) component in both the steps (1) and (2). Preferably, the step (1) is a step in which the (B) component in whole is molten and kneaded to obtain a kneaded mixture.

Alternatively, a part of the (A) component is preferably added in the step (1). It is also a preferable method to add pellets prepared by preliminarily melting and kneading the (A) component and the styrene-butadiene copolymer modified with a functional group serving as the (C) component in the step (2).

These production methods can obtain the resin composition of the present embodiment having excellent impact resistance, tensile strength and chemical resistance.

The melting and kneading machine suitably used for melting and kneading each component in the method for producing the resin composition in the present embodiment may be, but is not particularly limited to, a melting and kneading machine described in JP2021-008533A.

[Molded Products]

Molded products can be obtained from the resin composition of the present embodiment.

The molded products may include, but are not particularly limited to, for example, automotive parts, interior and exterior parts of electrical equipment, and other parts. Automobile parts may include, but are not particularly limited to: for example, exterior parts such as bumpers, fenders, door panels, moldings, emblems, engine hoods, wheel caps, roofs, spoilers, aero parts, etc.; interior parts such as instrument panels, console boxes, trims, etc.; secondary battery container parts installed in automobiles, electric vehicles, hybrid electric vehicles, power-assisted bicycles, wheelchairs, etc.; and lithium-ion secondary battery parts, etc. Interior and exterior parts of electrical equipment may include, but are not particularly limited to, for example, computers and their peripheral equipment, junction boxes, connectors, OA equipment, cabinets for TVs, videos or disc players, chassis for videos or disc players, and components used in refrigerators, air conditioners, LCD projectors, smart phones, tablets, and the like. Other parts include wires or cables obtained by coating metal conductors or optical fibers, fuel cases for solid methanol batteries, fuel cell water distribution pipes, tanks for water cooling, boiler exterior cases, ink peripheral parts of inkjet printers or printer chassis, furniture (chairs, etc.), water piping and fittings, etc.

(Method for Manufacturing Molded Products)

The molded products can be produced by molding the resin composition.

Method for manufacturing molded products include, but are not particularly limited to, for example, injection molding, extrusion molding, profile extrusion molding, hollow molding, compression molding, and the like. Injection molding is preferred, from the viewpoint of more effectively obtaining the effects of the present disclosure.

### Examples

Hereinafter, the present embodiment will be described using examples. Note that the present disclosure is not limited thereto.

Raw materials used for the resin compositions and molded products in the examples and comparative examples are listed below.

### —(A) Component—

(A-i) Clear rPET Flakes 3A (recycled polyethylene terephthalate resin derived from beverage PET bottles) manufactured by Diyou Fibre (M) Sdn Bhd., intrinsic viscosity of 0.72 dl/g

(A-ii) SHINPET 5511HF manufactured by Shinko Synthetic Fibers Corp., intrinsic viscosity of 0.80 dl/g

—(B) Component—

(B-i): Polyphenylene ether having a reduced viscosity (ηₛₚ/c: 0.42 g/dL of a chloroform solution) of 0.51 dL/g obtained by oxidative polymerization of 2,6-xylenol

(B-ii): Polyphenylene ether having a reduced viscosity (ηₛₚ/c: 0.5 g/dL of a chloroform solution) of 0.42 dL/g obtained by oxidative polymerization of 2,6-xylenol

The reduced viscosity of the (B) component was measured using ηₛₚ/c 0.5 g/dL of a chloroform solution in a Ubbelohde viscometer under a condition at a temperature of 30° C.

—(C) Component—

An unmodified block copolymer was synthesized with a polymer block A consisting of polystyrene and a polymer block B consisting of polybutadiene. Properties of the resulting block copolymer will be described below.

(C-i): Styrene-butadiene copolymer unmodified with a functional group

Polystyrene content in the block copolymer before hydrogenation: 30% by mass, Mn of the block copolymer after hydrogenation: 173,000, Mn of the polystyrene block: 25,950, Mn of the polybutadiene block: 121,110, a molecular weight distribution of the block copolymer before hydrogenation (Mw/Mn): 1.08, an amount of 1,2-vinyl bond (the total vinyl bond amount) in the polybutadiene block before hydrogenation: 30%, and a hydrogenation ratio to a polybutadiene portion constituting the polybutadiene block: 99%.

The content of the vinyl aromatic compound was measured using an ultraviolet spectrophotometer. Mn was determined using GPC (mobile layer: chloroform, standard material: polystyrene). The molecular weight distribution (Mw/Mn) was calculated by dividing the weight average molecular weight (Mw), which had been obtained by a known method, by Mn using GPC (mobile layer: chloroform, standard material: polystyrene). The total vinyl bond amount was measured using an infrared spectrophotometer and calculated according to the method described in Analytical Chemistry, Volume 21, No. 8, August 1949. The hydrogenation ratio was measured by nuclear magnetic resonance (NMR). The mixing ratio was determined by a peak area ratio at the time of the GPC measurement.

(C-ii): Styrene-butadiene copolymer modified with an amino group

Styrenic thermoplastic elastomer obtained by the following process.

4600 g of purified cyclohexane, 0.69 g of tetrahydrofuran (THF), 0.69 g of tetramethylethylenediamine (TMEDA), and 132 g of styrene were introduced in a tank-type reactor having an internal volume of 12 L equipped with a stirrer and jacket, and mixed at 100 rpm. The polymerization starting temperature was adjusted to 60° C. A cyclohexane solution of 20% by weight of n-butyl lithium (1.36 g of n-butyl lithium) was added, and polymerization of styrene was initiated. After styrene was completely polymerized, 544 g of 1,3-butadiene was added and completely polymerized, and 124 g of styrene was added and completely polymerized. Subsequently, 3.15 g of 1,3-dimethyl-2-imidazolidinone containing 0.12% by weight of 1,3-dimethyl-2-imidazolinone was added, followed by the addition of 0.74 g of methanol 15 minutes thereafter, whereby the polymerization reaction was ended. To the resulting copolymer, 130 ppm by weight of hydrogenation catalyst was added as titanium relative to the weight of the copolymer, and the hydrogenation reaction was carried out at a hydrogen pressure of 0.7 MPa and a temperature of 65° C. After the reaction was finished, 1 g of methanol was added, and the copolymer was removed from the reactor. Next, 0.3% by weight of octadecyl-3-(3,5-di-t-butyl-4-hydroxyphenyl) propionate was added as a stabilizer relative to the weight of the copolymer. Furthermore, the resulting copolymer rubber solution was dropped into boiling water being stirred, and the solvent was removed by steam stripping to obtain partially hydrogenated styrene-butadiene block copolymer rubber in a crumbly state, which was then subjected to a drying process. The hydrogenated catalyst was prepared by adding 1 L of dried and purified cyclohexane in a reaction vessel with nitrogen replacement, adding 100 mmol of dichlorobis (η⁵-2,4-cyclopentadien-1-yl) titanium, adding an n-hexane solution containing 200 mmol of trimethylaluminum while sufficient stirring, and allowing reaction at room temperature for about 3 days. Polystyrene content in the block copolymer before hydrogenation: 32% by mass, Mn of the block copolymer after hydrogenation: 66,000, Mn of the polystyrene block: 10,560, Mn of the polybutadiene block: 44,880, a molecular weight distribution (Mw/Mn) of the block copolymer before hydrogenation 1.11; an amount of 1,2-vinyl bond (the total vinyl bond amount) in the polybutadiene block before hydrogenation: 38%; and a hydrogenation ratio to the polybutadiene portion comprising the polybutadiene block: 88%.

—(D) Component—

Styrenic glycidyl methacrylate (“MarProof G-1005S” manufactured by NOF CORPORATION, the content of the styrene monomer unit of 95% by mass, epoxy equivalent of 3300 g/eq, Tg 96° C., Mw 100,000)

—(E) Components—

(E-i) Carbon black (Mitsubishi Carbon Black #950 manufactured by Mitsubishi Chemical Corporation)

(E-ii) Glass fiber (ECS03T-187 manufactured by Nippon Electric Glass Co., Ltd., cross-sectional diameter of 13 μm, fiber length of 3 mm)

—Other Components—

Molten and kneaded mixture α of the (A-i) component and the (C-ii) component

A molten and kneaded mixture obtained by mixing the (A-i) component and the (C-ii) component at a mass ratio of 63:5, feeding the mixture of the (A-i) component and the (C-ii) component from the first raw material feeding inlet into a twin-screw extruder (ZSK-25, L/D=35, manufactured by Coperion GmbH) with barrel temperature set at 290° C., and melting and kneading a resulting material under a condition of a screw speed of 300 rpm and an extrusion rate of 18 kg/h to obtain pellets.

—Methods for Measuring and Evaluating Physical Properties of Resin Composition—

(1) Average particle diameter of the phase of the (B) component dispersed in the phase of the (A) component

The resulting pellets of the resin composition were fed into a small injection molding machine (product name: SE75EV-A, manufactured by Sumitomo Heavy Industries, Ltd.) with the cylinder temperature set at 270° C. and subjected to molding under a condition of mold temperature of 120° C., injection pressure of 100 MPa, injection time for 5 seconds and cooling time for 15 seconds to obtain an ISO dumbbell for evaluation. From the dumbbell, specimens were cut out with a diamond saw and encased in epoxy resin. Cross-sections of the specimens were electron-stained with ruthenium tetroxide and conductively treated, whereby specimens for microscopic examination were obtained. Using a scanning electron microscope (product name: SU8220, manufactured by Hitachi High-Tech Corporation), an image was obtained at a magnification of 5,000 times in a mode for capturing a reflected electron image with an acceleration voltage of 4 kV. The image was observed and separated into an (A) component area observed as a dark area and a (B) component area observed as a blight area by image processing using binarization. As a method for binarization, the reflected electron image was subjected to the procedure set forth below using image analysis software (National Institutes of Health/imageJ).

(1) Binarization of the Reflected Electron Image Using Otsu's Method

(2) From a binarized image, a matrix (the phase of the (A) component) and a dispersed phase (the phase of the (B) component) were identified, and a short diameter and a long diameter of the identified dispersed phase (the phase of the (B) component) were measured to determine their average value as the particle diameter. By calculating an average particle diameter for arbitrary 4000 dispersed phases in the image, an average particle size of the dispersed phases were determined.

(2) Value of C_{A}/C_{B}

The resulting pellets of the resin composition were frozen and pulverized, and 500 mg of this sample was added to 10 mL of toluene, left stand at room temperature for 18 hours and then centrifuged at 3000 rpm at 20° C. for 1 hour to separate into supernatant and precipitate. This supernatant was vacuum dried and designated as “concentrate 1”. The concentrate 1 was vacuum dried to volatilize all the solvent. Next, 10 mL of chloroform was added and dissolved at room temperature, and fractions of the mixture were subjected to ¹H-NMR measurement in deuterated chloroform to determine peak areas of signals respectively corresponding to the (B) component and the (C) component and, from a total weight of the “concentrate 1”, an amount of the (B) component and an amount of the (C) component C_{T} soluble in toluene. Also, to the fractions that had turned into precipitate in the first centrifugation step, 10 mL of a first mixed solvent in which HFIP: chloroform=1:1 (volume ratio) was added and thus obtained mixture was left stand for 18 hours at room temperature. The mixture was then centrifuged at 3000 rpm at 20° C. for 1 hour to separate into supernatant and precipitate. This supernatant was vacuum dried and designated as “concentrate 2”. The concentrate 2 was vacuum dried to volatilize all the solvent and dissolved in 20 mL of a mixed solvent in which HFIP: chloroform=1:3 (volume ratio) at 40° C. Fractions of the resulting mixture were subjected to ¹H-NMR measurement in a mixed solvent in which heavy HFIP: heavy chloroform=3:2 (volume ratio), to determine the peak areas of signals respectively corresponding to the (A) component and the (C) component and, from a total weight of the “concentrate 2”, the amount of the (A) component and the amount of the (C) component C_{H} soluble in the first mixed solvent. In this way, the amounts of the (A) component, the (B) component and the (C) component (a total amount of C_{T} and C_{H}) in the resin composition were determined first. Next, 500 mg of the same frozen and pulverized samples were added to 20 mL of chloroform and shaken at room temperature for 6 hours. The resulting solution was filtered through a disposable filter with a 0.45 m mesh opening. The extracted solution was air dried and then vacuum dried at 60° C. for 12 hours. An amount of residue after the vacuum drying was considered to be a total amount of the (B) component and the C_{B} component. An amount of C_{B} was determined by subtracting the amount of the (B) component, which had been determined in advance, from the total amount. Then, an amount of C_{A} was obtained by subtracting the amount of C_{B} from the amount of the (C) component, which had been determined in advance. Then, the value of C_{A}/C_{B} was obtained by dividing C_{A} by C_{B}.

(3) Tensile Strength

(1) To measure a maximum tensile strength (MPa), tensile strength test was carried out on the ISO dumbbell that had been injection-molded under the same conditions as those used for the measurement of the average particle diameter of the phase of the (B) component dispersed in the phase of the (A) component, according to ISO 527 under a condition of 23° C. and 50 RH %.

(4) Impact Resistance

(1) To measure a Charpy impact value (kJ/m²), a Charpy impact test with a notch was carried out on the ISO dumbbell injection-molded under the same conditions as those used for the measurement of the average particle diameter of the phase of the (B) component dispersed in the phase of the (A) component, according to ISO 179 under the condition of 23° C. and 50 RH %.

(5) Chemical Resistance

The obtained pellets of the resin composition were fed into a small injection molding machine (product name: SE75EV-A, manufactured by Sumitomo Heavy Industries, Ltd.) with the cylinder temperature set at 270° C. and molded into a flat plate in size of 150 mm×150 mm×3 mm under a condition of mold temperature of 120° C., injection pressure of 100 MPa, injection time for 10 seconds and cooling time for 15 seconds. From this flat plate, a sample in size of 75 mm×12.7 mm×3 mm was cut out and set in a bending form designed to continuously change strain of the sample. Petroleum benzene (manufactured by Takabishi Chemical Co., Ltd.) was applied to the surface of the sample, and the sample was then left stand under the condition of 23° C. and 50 RH % for 48 hours. After 48 hours, the sample was subjected to strain, and a stopping position of the bending form was measured when cracks appeared on the surface of the sample, to obtain an amount of critical strain (%) indicating the amount of critical strain which does not generate cracks. An evaluation criterion was as follows: the higher the value of the amount of critical strain, the better the chemical resistance.

### Examples 1 to 16, Comparative Examples 1 to 10

The twin-screw extruder described above was used as the melting and kneading machine to produce the resin composition in each of the examples and the comparative examples. The L/D of the extruder was set to 35.

The twin-screw extruder was provided with a first material feeding inlet arranged upstream in the direction of material flow, a first vacuum vent arranged downstream from the first material feeding inlet, a second material feeding inlet arranged downstream from the first vacuum vent, a third material feeding inlet arranged downstream from the second material feeding inlet, and a second vacuum vent arranged downstream from the third material feeding inlet.

The barrel temperature of the twin-screw extruder was set to 320° C. from the first material feeding inlet to the second material feeding inlet and 290° C. downstream from the second material feeding inlet. The pellets of the resin composition were produced under the condition of a screw speed of 300 rpm and an extrusion rate of 18 kg/h. The configuration of the twin-screw extruder is shown in Table 1.

TABLE 1

| | First Raw | | | | | Second Raw | | | Third Raw | | | |
|---|---|---|---|---|---|---|---|---|---|---|---|---|
| | Material | | | | First | Material | | | Material | | Second | |
| | Feeding | | | | Vacuum | Feeding | | | Feeding | | Vacuum | |
| | Inlet | | | | Vent | Inlet | | | Inlet | | Vent | |
| | C1 | C2 | C3 | C4 | C5 | C6 | C7 | C8 | C9 | C10 | C11 | C12 |
| Setting | 320° C. | | | | | 290° C. | | | | | | |
| Temperature | | | | | | | | | | | | |

The (A) to (E) components and the molten and kneaded mixture α were fed into the twin-screw extruder as shown in Table 2 and Table 3 to obtain the pellets of the resin composition.

The physical properties of each of the examples and comparative examples were measured and evaluated using the measurement methods (1) to (5) described above. The results are shown in Table 2 and Table 3.

TABLE 2

| | | | | Exam- | Exam- | Exam- | Exam- | Exam- | Exam- | Exam- | Exam- |
|---|---|---|---|---|---|---|---|---|---|---|---|
| | | | | ple | ple | ple | ple | ple | ple | ple | ple |
| | | | | 1 | 2 | 3 | 4 | 5 | 6 | 7 | 8 |
| Composition | First raw material | Component (A-i) | Parts by mass | 0 | 0 | 0 | 0 | 0 | 0 | 0 | 0 |
| | feeding inlet | Component (B-i) | Parts by mass | 0 | 0 | 0 | 0 | 26 | 0 | 0 | 0 |
| | | Component (B-i) | Parts by mass | 26 | 26 | 26 | 26 | 0 | 26 | 26 | 26 |
| | | Component (C-i) | Parts by mass | 5 | 5 | 5 | 5 | 5 | 5 | 2 | 8 |
| | | Component (D) | Parts by mass | 1 | 1 | 1 | 1 | 1 | 1 | 1 | 1 |
| | Second raw | Component (A-i) | Parts by mass | 63 | 63 | 63 | 63 | 63 | 0 | 0 | 0 |
| | material feeding | Component (A-ii) | Parts by mass | 0 | 0 | 0 | 0 | 0 | 63 | 63 | 63 |
| | inlet | Component (C-ii) | Parts by mass | 5 | 5 | 5 | 5 | 5 | 5 | 8 | 2 |
| | | Component (E-i) | Parts by mass | 0.5 | 0 | 0.5 | 0.5 | 0.5 | 0.5 | 0.5 | 0.5 |
| | | Molten and kneaded | Parts by mass | 0 | 0 | 0 | 0 | 0 | 0 | 0 | 0 |
| | | mixture α | | | | | | | | | |
| | Third raw | Component (E-ii) | Parts by mass | 0 | 0 | 10 | 30 | 30 | 30 | 30 | 30 |
| | material feeding | | | | | | | | | | |
| | inlet | | | | | | | | | | |
| Physical | (1) Average particle diameter | | μm | 1.4 | 1.2 | 1.3 | 1.3 | 1.2 | 1.1 | 4.8 | 1.3 |
| properties | (2) Value of [C_{A}/C_{B}]/[Aₘ/Bₘ] | | — | 0.15 | 0.17 | 0.13 | 0.12 | 0.14 | 0.13 | 0.37 | 0.08 |
| Evaluation | (3) Tensile strength | | MPa | 51 | 49 | 63 | 95 | 97 | 99 | 90 | 89 |
| | (4) Impact resistance (Charpy | | kJ/m² | 5.5 | 5.6 | 6.1 | 10.2 | 10.3 | 10.1 | 9.0 | 9.4 |
| | impact strength) | | | | | | | | | | |
| | (5) Chemical resistance (Critical strain) | | % | 1.1 | 0.9 | 1.1 | 1.1 | 1.2 | 1.2 | 1.0 | 1.0 |
| | | | | Exam- | Exam- | Exam- | Exam- | Exam- | Exam- | Exam- | Exam- |
| | | | | ple | ple | ple | ple | ple | ple | ple | ple |
| | | | | 9 | 10 | 11 | 12 | 13 | 14 | 15 | 16 |
| Composition | First raw material | Component (A-i) | Parts by mass | 0 | 0 | 0 | 0 | 0 | 0 | 5 | 0 |
| | feeding inlet | Component (B-i) | Parts by mass | 0 | 0 | 0 | 0 | 0 | 0 | 0 | 0 |
| | | Component (B-i) | Parts by mass | 45 | 5 | 28 | 26 | 26 | 28 | 26 | 26 |
| | | Component (C-i) | Parts by mass | 4.5 | 5 | 2 | 5 | 5 | 0 | 5 | 5 |
| | | Component (D) | Parts by mass | 1 | 1 | 1 | 0.3 | 0.5 | 1 | 1 | 1 |
| | Second raw | Component (A-i) | Parts by mass | 0 | 0 | 0 | 0 | 0 | 0 | 58 | 0 |
| | material feeding | Component (A-ii) | Parts by mass | 45 | 84 | 67 | 63.7 | 63.5 | 66 | 0 | 0 |
| | inlet | Component (C-ii) | Parts by mass | 4.5 | 5 | 2 | 5 | 5 | 5 | 5 | 0 |
| | | Component (E-i) | Parts by mass | 0.5 | 0.5 | 0.5 | 0.5 | 0.5 | 0.5 | 0.5 | 0.5 |
| | | Molten and kneaded | Parts by mass | 0 | 0 | 0 | 0 | 0 | 0 | 0 | 68 |
| | | mixture α | | | | | | | | | |
| | Third raw | Component (E-ii) | Parts by mass | 30 | 30 | 30 | 30 | 30 | 30 | 30 | 30 |
| | material feeding | | | | | | | | | | |
| | inlet | | | | | | | | | | |

| | | | | | | | | | | |
|---|---|---|---|---|---|---|---|---|---|---|
| Physical | (1) Average particle diameter | μm | 2.2 | 0.9 | 1.4 | 2.5 | 4.0 | 3.7 | 1.7 | 2.1 |
| properties | (2) Value of [C_{A}/C_{B}]/[Aₘ/Bₘ] | — | 0.10 | 0.27 | 0.15 | 0.16 | 0.18 | 0.43 | 0.85 | 0.29 |
| Evaluation | (3) Tensile strength | MPa | 82 | 78 | 103 | 84 | 88 | 90 | 86 | 80 |
| | (4) Impact resistance (Charpy | kJ/m² | 8.3 | 9.7 | 9.1 | 8.7 | 9.5 | 8.4 | 7.6 | 11.2 |
| | impact strength) | | | | | | | | | |
| | (5) Chemical resistance (Critical strain) | % | 0.8 | 1.3 | 1.0 | 0.7 | 0.8 | 0.9 | 1.0 | 1.0 |

TABLE 3

| | | | | Compar- | Compar- | Compar- | Compar- | Compar- |
|---|---|---|---|---|---|---|---|---|
| | | | | ative | ative | ative | ative | ative |
| | | | | Exam- | Exam- | Exam- | Exam- | Exam- |
| | | | | ple 1 | ple 2 | ple 3 | ple 4 | ple 5 |
| Composition | First raw material | Component (A-i) | Parts by mass | 0 | 0 | 0 | 0 | 10 |
| | feeding inlet | Component (B-ii) | Parts by mass | 26 | 26 | 26 | 26 | 26 |
| | | Component (C-i) | Parts by mass | 10 | 10 | 10 | 10 | 5 |
| | | Component (D) | Parts by mass | 1 1 | 1 | 1 | 0 | 1 |
| | Second raw | Component (A-i) | Parts by mass | 63 | 63 | 63 | 63 | 53 |
| | material feeding | Component (C-ii) | Parts by mass | 0 | 0 | 0 | 0 | 5 |
| | inlet | Component (E-i) | Parts by mass | 0.5 | 0.5 | 0.5 | 0.5 | 0.5 |
| | Third raw | Component (E-ii) | Parts by mass | 0 | 10 | 30 | 30 | 30 |
| | material feeding | | | | | | | |
| | inlet | | | | | | | |
| Physical | (1) Average particle diameter | | μm | 1.4 | 1.3 | 1.3 | 10.5 | 3.7 |
| properties | (2) Value of [C_{A}/C_{B}]/[Aₘ/Bₘ] | | — | 0 | 0 | 0 | 0 | 1.00 |
| Evaluation | (3) Tensile strength | | MPa | 46 | 56 | 82 | 74 | 80 |
| | (4) Impact resistance (Charpy impact strength) | | kJ/m² | 2.6 | 3.0 | 6.7 | 6.2 | 7.3 |
| | (5) Chemical resistance (Critical strain) | | % | 1.0 | 1.0 | 1.1 | 0.8 | 0.8 |
| | | | | Compar- | Compar- | Compar- | Compar- | Compar- |
| | | | | ative | ative | ative | ative | ative |
| | | | | Exam- | Exam- | Exam- | Exam- | Exam- |
| | | | | ple 6 | ple 7 | ple 8 | ple 9 | ple 10 |
| Composition | First raw material | Component (A-i) | Parts by mass | 30 | 63 | 0 | 0 | 0 |
| | feeding inlet | Component (B-ii) | Parts by mass | 26 | 26 | 28 | 26 | 63 |
| | | Component (C-i) | Parts by mass | 5 | 5 | 1 | 0 | 5 |
| | | Component (D) | Parts by mass | 1 | 1 | 1 | 1 | 1 |
| | Second raw | Component (A-i) | Parts by mass | 33 | 0 | 69 | 63 | 26 |
| | material feeding | Component (C-ii) | Parts by mass | 5 | 5 | 1 | 10 | 5 |
| | inlet | Component (E-i) | Parts by mass | 0.5 | 0.5 | 0.5 | 0.5 | 0.5 |
| | Third raw | Component (E-ii) | Parts by mass | 30 | 30 | 30 | 30 | 30 |
| | material feeding | | | | | | | |
| | inlet | | | | | | | |

| | | | | | | | |
|---|---|---|---|---|---|---|---|
| Physical | (1) Average particle diameter | μm | >20.0 | >20.0 | 1.4 | 7.8 | ^{a} |
| properties | (2) Value of [C_{A}/C_{B}]/[Aₘ/Bₘ] | — | 0.18 | 0.29 | 0.15 | 0.47 | n.d. ^{b} |
| Evaluation | (3) Tensile strength | MPa | 76 | 74 | 100 | 85 | 72 |
| | (4) Impact resistance (Charpy impact strength) | kJ/m² | 6.3 | 6.1 | 6.4 | 5.9 | 5.9 |
| | (5) Chemical resistance (Critical strain) | % | 0.5 | 0.4 | 1.0 | 0.9 | 0.4 |

^{a} (A) non-continuous phase,
^{b} unmeasurable

As shown in Table 2 and Table 3, the resin compositions of the examples were found to provide polyethylene terephthalate resin compositions having excellent impact resistance, tensile strength and chemical resistance, as compared to the resin compositions of the comparative examples.

### INDUSTRIAL APPLICABILITY

According to the present disclosure, polyethylene terephthalate resin compositions having excellent impact resistance, tensile strength and chemical resistance which can be applied to mechanical parts and structures can be obtained. Molded products containing the resin compositions of the present disclosure are suitable for use as automotive parts, interior and exterior parts of electrical equipment, and other parts.

1. A resin composition comprising:
a (A) polyethylene terephthalate resin;
a (B) polyphenylene ether resin;
a (C) styrenic thermoplastic elastomer; and
a (D) styrenic copolymer having a glycidyl group,
wherein, relative to a total of 100 parts by mass of the (A) polyethylene terephthalate resin, the (B) polyphenylene ether resin, the (C) styrenic thermoplastic elastomer and the (D) styrenic copolymer having the glycidyl group,
an amount of the (A) polyethylene terephthalate resin is 40 to 90 parts by mass,
an amount of the (B) polyphenylene ether resin is 5 to 55 parts by mass,
an amount of the (C) styrenic thermoplastic elastomer is 3 to 20 parts by mass,
an amount of the (D) styrenic copolymer having the glycidyl group is 0.1 to 5 parts by mass, and
when C_{A} represents a mass of the (C) styrenic thermoplastic elastomer present in a phase of the (A) polyethylene terephthalate resin;
C_{B} represents a mass of the (C) styrenic thermoplastic elastomer present in a phase of the (B) polyphenylene ether resin;
Aₘ represents a mass of the (A) polyethylene terephthalate resin in the resin composition; and
Bₘ represents a mass of the (B) polyphenylene ether resin in the resin composition,
a relationship between a mass ratio of C_{A}/C_{B} and a mass ratio of Aₘ/Bₘ satisfies 0.05≤[C_{A}/C_{B}]/[Aₘ/Bₘ]≤0.90, and
an average particle diameter of the phase of the (B) polyphenylene ether resin dispersed in the phase of the (A) polyethylene terephthalate resin is 0.1 to 5 μm.

2. The resin composition according to claim 1, wherein the (C) styrenic thermoplastic elastomer is one or more selected from the group consisting of a hydrogenated block copolymer and a modified hydrogenated block copolymer, and
in the hydrogenated block copolymer, at least a portion of a block copolymer including a polymer block A composed mainly of a vinyl aromatic compound and a polymer block B composed mainly of a conjugated diene compound is hydrogenated.

3. The resin composition according to claim 1, wherein the (C) styrenic thermoplastic elastomer includes a styrenic thermoplastic elastomer modified with an amino group or a maleic anhydride group.

4. The resin composition according to claim 1, wherein the relationship satisfies 0.05≤[C_{A}/C_{B}]/[Aₘ/Bₘ]≤0.50.

5. The resin composition according to claim 2, wherein the polymer block A has a number-average molecular weight (Mn) of 5,000 to 28,000.

6. The resin composition according to claim 2, wherein the polymer block B has a number-average molecular weight (Mn) of 20,000 to 150,000.

7. The resin composition according to claim 2, wherein the content of vinyl aromatic compound unit in the (C) styrenic thermoplastic elastomer before hydrogenation is 30 to 50% by mass.

8. The resin composition according to claim 2, wherein a ratio of the total of 1,2-vinyl bond and 3,4-vinyl bond to ethylenic double bond in the conjugated diene compound unit contained in the (C) styrenic thermoplastic elastomer is between 25% and 60%.

9. The resin composition according to claim 2, wherein the (C) styrenic thermoplastic elastomer has a hydrogenation ratio between 60% and 100%.

10. The resin composition according to claim 2, wherein the (C) styrenic thermoplastic elastomer after hydrogenation has a molecular weight peak of 10,000 to 250,000 in standard polystyrene equivalent by GPC measurement.

11. The resin composition according to claim 2, wherein the (C) styrenic thermoplastic elastomer has a molecular weight distribution (Mw/Mn) before hydrogenation of 1.01 to 1.50.

12. The resin composition according to claim 2, wherein the (C) styrenic thermoplastic elastomer has a mass ratio of an unmodified hydrogenated block copolymer to a modified hydrogenated block copolymer of 1:9 to 9:1.

13. The resin composition according to claim 1, comprising the (A) polyethylene terephthalate resin and the (C) styrenic thermoplastic elastomer as a molten and kneaded mixture of these two components.

14. The resin composition according to claim 13, wherein the (C) styrenic thermoplastic elastomer is a styrenic thermoplastic elastomer modified with an amino group or a maleic anhydride group.

15. The resin composition according to claim 1, wherein an average particle diameter of the phase of the (B) polyphenylene ether resin is between 0.5 μm and 5.0 μm.

16. The resin composition according to claim 1, further comprising an (E) additive,
wherein the (E) additive is selected from a group consisting of an inorganic filler and a coloring agent.

17. The resin composition according to claim 16, wherein the (E) additive is selected from a group consisting of glass fiber and carbon black.

18. A molded product comprising the resin composition according to claim 1.
